(19) United States
(12) Patent Application Publication
(10) Pub. No.: US 2020/0072689 A1
(43) Pub. Date: Mar. 5, 2020

(54) Networked Impact System and Apparatus

(71) Applicant: Braven Sport Combat Equip, Inc, Montebello, CA (US)

(72) Inventor: Robert Steven Garcia, Montebello, CA (US)

(73) Assignee: Braven Sport Combat Equip, Inc, Montebello, CA (US)

(21) Appl. No.: 16/614,754

(22) PCT Filed: May 18, 2018
(86) PCT No.: PCT/US18/33451

§ 371 Date: Nov. 18, 2019

Related U.S. Application Data
(60) Provisional application No. 62/508,622, filed on May 19, 2017.

(51) Int. Cl. G01L 5/00; A63B 24/00; A63B 22/00; H04W 84/18

(52) U.S. Cl. CPC G01L 5/0052; A63B 24/0062; A63B 2022/0092; H04W 84/18; A63B 22/00

(57) ABSTRACT

An impact system, method, and apparatus including a sensor wall defining a substantially vertical wall. A number of sensors are embedded in the sensor wall. The number of sensors are configured to sense one or more impacts simultaneously. The impact system further includes a base securing the sensor wall. The base is fixedly attached to a floor or ground. The impact system further includes supports integrated with the sensor wall securing the sensor wall to the base.

### PRIORITY STATEMENT

This application claims priority to U.S. Provisional Patent Application 62/508,622, filed on May 19, 2017, and entitled Networked Impact System and Apparatus, hereby incorporated by reference in its entirety.

### BACKGROUND

### I. Field of the Disclosure

The illustrative embodiments relate to sports performance and physical rehabilitation.

### II. Description of the Art

The utilization of advanced exercise equipment has increased significantly recent years. There is a level of complexity in the installation and usage of equipment that measure sensor input including striking, punching, kicking, bouncing, and forceful percussions from projectile, such as medicine balls, arrows, basket balls, baseballs, footballs, and golf clubs.

### SUMMARY OF THE DISCLOSURE

The illustrative embodiments provide an impact system, method, and apparatus including a sensor wall defining a substantially vertical wall. A number of sensors are embedded in the sensor wall. The number of sensors are configured to sense one or more impacts simultaneously. The impact system further includes a base securing the sensor wall. The base is fixedly attached to a floor or ground. The impact system further includes supports integrated with the sensor wall securing the sensor wall to the base.

Another embodiment provides a method of utilizing a sensor wall for detecting impacts. A number of sensors are calibrated within the sensor wall. An impact are detected. Impact information associated with the impact is measured. The impact information are communicated to one or more associated devices. The impact system of claim 1, wherein the base includes a sleeve configured to receive the sensor wall, and wherein the base includes a flange for securing the base to the floor or the ground utilizing one or more connectors.

Another embodiment provides connectors for connecting the sensor wall to the base. In one embodiment, the connectors are bolts. In another embodiment, the sensor wall communicates with one or more electronic devices directly or through one or more networks, such as computing or wireless communications devices. In another embodiment, the impact system includes indicators integrated with a surface of the sensor wall that display striking information. In another embodiment, the striking information includes at least a time to strike and a location on the sensor wall to strike. In one embodiment, the numerous sensors measure a time of impact, a location of the impact on the sensor wall, a speed of the impact, and the force of the impact. For example, the numerous sensors may include accelerometers and capacitance or resistive sensors. In one embodiment, the base is removable attached to the ground or floor. In one embodiment, the logic is configured to execute one or more training or testing programs for a user. The sensor wall may sense impacts directly from the user utilizing one or more body parts.

In one embodiment, the numerous sensors may be calibrated within the sensor wall. The sensor wall may analyze the impact data to generate results, wherein the results are communicated as part of the impact information. For example, the impact data may include a location of the impact on the sensor wall, a time of the impact, a speed associated with the impact, and a force associated with the impact.

### BRIEF DESCRIPTION OF THE DRAWINGS

Illustrated embodiments are described in detail below with reference to the attached drawing figures, which are incorporated by reference herein, and where:

FIG. 1 is a pictorial representation of a system in accordance with an illustrative embodiment;

FIG. 2 is a front view of the system of FIG. 1 in accordance with an illustrative embodiment;

FIG. 3 is a side view of the system of FIG. 1 in accordance with an illustrative embodiment;

FIG. 4 is a top view of the system of FIG. 1 in accordance with an illustrative embodiment;

FIG. 5 is a pictorial representation of another impact system in accordance with an illustrative embodiment;

FIG. 6 is a block diagram of an impact system in accordance with an illustrative embodiment;

FIG. 7 is a flowchart of a process configuring the impact system in accordance with an illustrative embodiment; and

FIG. 8 is a flowchart of a process for processing data from an impact system in accordance with an illustrative embodiment.

FIG. 9 depicts a computing system in accordance with an illustrative embodiment.

### DETAILED DESCRIPTION OF THE DISCLOSURE

The illustrative embodiments provide a networked impact sensor system, method, and apparatus. The illustrative embodiments may be utilized for the creation of detailed analysis of percussive strikes. The data captured from the illustrative system may be utilized to perform analysis (e.g., strength, strike analysis, trajectory, technique, impact footprint, duration, etc.) and training.

In one embodiment, the illustrative embodiments allow training sessions to record impacts in comprehensive and customizable ways. For example, the system may record the position and orientation of a fist when striking a surface, the strength of the strike (e.g., lbs./square inch, Newtons, joules, etc.), speed of impact, intervals between strikes, and so forth. The information may be digitized, analyzed (locally or externally), and communicated to one or more designated devices, systems, equipment, components, users, or receiving parties.

In one embodiment, the system includes a sensor network that is embedded within a sensor wall. The sensor wall may include one or more layers (e.g., surface, sensor layer, padding layer, structure layer, etc.). The sensor wall may include visual cues for indicating strike locations, directions, techniques, and instructions. For example, integrated lights or projected lights (e.g., arrows, targets, people, etc.) may indicate targets, types of targets, strike methods, or so forth. The sensor wall may be struck by appendages or portions of the human body, balls (e.g., medicine ball, rubber balls, footballs, baseballs, tennis balls, basketballs, shot-put, soccer ball, etc.), weapons, or sports instruments. The sensor wall of the system may capture and automatically transmit data via a secured wireless or wired network for data processing and analysis. For example, the system may capture data regarding the speed, frequency, and accuracy of strikes or impacts. Impacts, strikes, collisions, hits, attacks, or other physical reactions may be referred to generally herein as impacts. As a result, the illustrative embodiments enable the real-time capture of data. Analysis or results of the captured data may also be displayed in real-time.

The illustrative embodiments may be utilized by medical professionals, athletes (e.g., professional, amateur, recreational, etc.) healthcare providers, trainers, coaches, parents, and any number of individuals, groups, organizations, and businesses. Raw or processed data from the system may be integrated with other data from wearables (e.g., smart watches, hearables, bands, vision systems, etc.). In addition, the measurements or results from the system may be communicated to any number of wireless, computing, entertainment, or display devices, systems, equipment, or components. The description of structure, functionality, processes, and methods of the various Figures is applicable across all of the Figures and description without regard to natural or artificial restrictions or limitations.

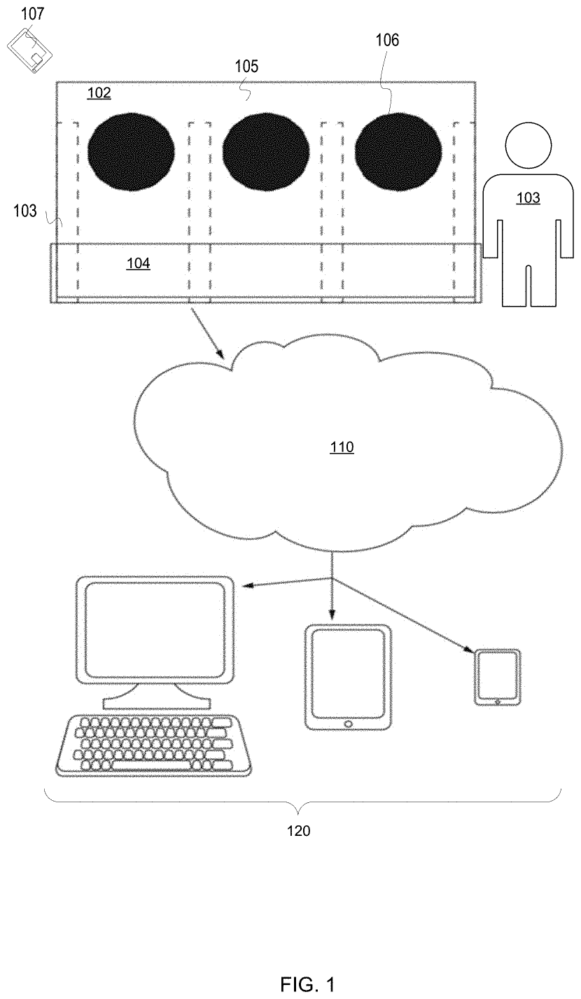

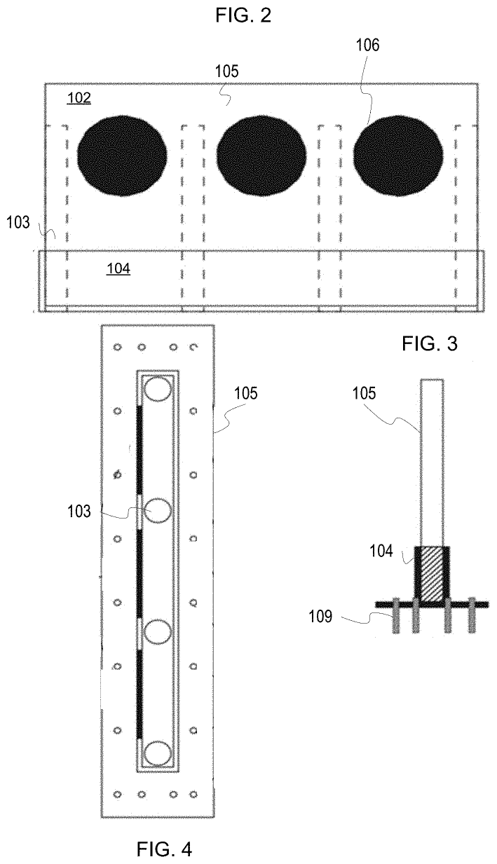

Turning now to FIGS. 1-4 showing a pictorial representation and different views of a system 100 in accordance with an illustrative embodiment. In one embodiment, the system 100 may include a sensor wall 102, a network 110, and devices 120. A user 103 is the individual that may be striking the sensor wall 102 or throwing an object at the sensor wall 102. In one embodiment, the system 100 may represent or be referred to as an impact system, percussion system, networked sensor wall, strike system, or so forth.

The size and shape of the sensor wall 102 may vary based on the applications, users, available space, and so forth. In one example, the sensor wall 102 may be approximately twelve feet wide by eight feet tall. However, the sensor wall 102 may represent various sizes and shapes suitable for the training, activity, or actions being performed. The sensor wall 102 may include a number of supports 103. The supports 103 sustain the components of the sensor wall 102. For example, the supports 103 may represent steel tubing. In another example, the supports 103 may represent a framework of I-beams, a metal/micro lattice, self-healing plastic, arches, and/or triangular frameworks, beams, cables, springs, poles, and/connectors. The sensor wall 102 may also include a base 104 that strengthens the sensor wall 102. In one embodiment, the base 104 is a steel upside down T-shaped sleeve that may be attached to the floor, ground, or other applicable surface. The base 104 may include one or more flanges for securing the base 104 in place. The sleeve may include a receptacle for sliding the sensor wall 102 into the sleeve from above or the side. For example, the base 104 may be bolted to a concrete foundation or floor utilizing bolts 109. The bolts 109 may also represent pins, pegs, stakes, straps, belts, suction cups, adhesives, or other connectors that secure the base 104 and associated sensor wall 102. The base 104 may be attached to the ground, floor, wall, ceiling, structure, or so forth.

In another embodiment, the base 104 may also be wide enough (on a portion that extends parallel to the ground) that it does not require fixed connectors to provide stability to the sensor wall 102. In another embodiment, the base 104 may be integrated with a floor, such as an opening or receptacle configured to receive a bottom portion of the sensor wall 102 for adding and removing the sensor wall 102 as needed.

In other embodiments, the sensor wall 102 may be hung from supports allowing the sensor wall 102 to move based on impacts or predefined motions. Cables, bars, springs, linkages, connectors, or other supports may be utilized to hold the sensor wall 102. One or more motors, pulleys, actuators, pistons, or other mechanisms may be utilized to pivot, rotate, swing, or otherwise move all or portions of the sensor wall 102.

The sensor wall 102 further includes a surface 105 including sensors 106. The surface 105 may be made of any number of support structures. For example, the surface 105 may represent canvas, nylon, leather, foam board, laminate, plywood, plastic, rubber, composite, or other support materials. The sensors 106 may be adhered or integrated with the surface 105 on an exterior or interior wall of the surface 105. The sensors 106 may also represent a separate sensor layer adjacent the surface 105.

The sensors 106 may further include any number of pressure sensors, piezo electric sensors, accelerometers, gyroscopes, optical fibers, Bragg gratings, resistance sensors, capacitance sensors, pressure pads, bladders, inductive sensors, or so forth. In one embodiment, the sensors 106 may include multiple layers that may be utilized to sense strike location, pressure/amplitude, impact footprint/size, direction, and so forth. The sensor wall 102 may recalibrate itself between hits, users, rounds, programs, initializations, or so forth to ensure accurate measurements are read. In another embodiment, the sensors 106 may be integrated in the sensor wall 102 beneath the surface 105 and one or more padding layers.

Although not specifically shown, the sensor wall 102 may include any number of indicators that provide the user information. For example, the indicators may be light emitting diodes or light strips that indicate where and when the user is to strike the sensor wall 102. The indicators may also represent a flexible array of lights integrated into a layer or layers of the sensor wall 102. For example, the flexible array of lights may use multiple colors to present moving targets, text, or so forth. In another embodiment, the sensor wall 102 may include one or more projectors 107 on the front side or back side of the sensor wall 102 or positioned externally from the sensor wall 102 for projecting information, targets, and so forth. The projector 107 may also include a camera system for analyzing the motion of the user 103 as well as the impacts generated by the user 103. The positioning of the indicators may correspond with the sensors 106 for performing accurate measurements of impacts. In one embodiment, the indicators may correspond to a human body, target, or so forth. The direction and strength of a strike may vary based on the intended location or target of the strike. In one embodiment, the indicators may be programmable to display any number of shapes, outlines, text, arrows, or other information, data, or images. The indicators may also include one or more integrated displays, such as an organic light emitting diodes (OLEDs), projection systems, or so forth. The indicators may also be utilized for dramatic effect or to provide a summary/history of strike data and information (e.g., strength, location, impact speed, trajectory, etc.).

The sensor wall 102 may also include any number of ports or interfaces for connecting an external display or other device. For example, any number of USB, Firewire, HDMI, or other enhanced connectors may be utilized. The sensor wall 102 may also have connectors or interfaces that interface with the base 104 to receive power from an interconnected power supply, perform data communications, and so forth. The interfaces may automatically interact in response to the sensor wall 102 being docked with or engaged with the base 104. In another embodiment, the interfaces of the sensor wall 102 and the base 104 may be magnetic and may automatically connect when placed in proximity to each other.

In one embodiment, the sensor wall 102 is free standing and may be capable of receiving sustained and repetitive strikes. For example, any number of canvas, leather, or rubber balls may be thrown at targets integrated with, printed on, or displayed on the surface 105. In one embodiment, the sensor wall 102 is a stand-alone device the measures, analyzes, processes and communicates information related to strikes, impacts, or so forth.

Measurements may be communicated through the network 110. Communications within the system 100 may occur through any number of networks which may include wireless networks, data or packet networks, cable networks, satellite networks, Internet Protocol television (IPTV) networks, private networks, publicly switched telephone networks (PSTN), or other types of communication networks. The network 110 is infrastructures for sending and receiving messages and signals according to one or more designated formats, standards, and protocols. The network 110 of the communications environment 100 may represent a single communication service provider or multiple communications services providers. The features, services, and processes of the illustrative embodiments may be implemented by one or more components of the system 100 independently or as a networked implementation.

The different devices and components of the system 100 may communicate using wireless communications, such as satellite connections, Wi-Fi, code division multiple access (CDMA) wireless networks, Bluetooth, Zigbee, and/or hardwired connections, such as Ethernet, fiber optics, T1, cable, DSL, high-speed trunks, and telephone lines. The devices 120 may communicate with the sensor wall 102 and the network 110 using any number of communications signals, protocols, or standards (e.g., Wi-Fi, cell signals, WiMAX, Bluetooth, etc.). The devices 102 may include any number of wireless or computing devices, such as cellular phones, Blackberry® devices, personal digital assistances (PDA), mp3 players, laptops, gaming devices, smart televisions/displays, virtual/augmented reality systems, wearables, holographic displays, multi-mode devices, and so forth. The communications network 110 may include various fiber optics, cables, transmission towers, antennas, or other elements for transmitting voice communications to the connected telephonic devices.

The system 100 may be utilized to measure physical or rehabilitation performance parameters. For example, the system 100 may be utilized by professional trainers, physical therapists, and physicians performing rehabilitation alike. The system 102 is formed from various materials and structures that support significant impacts over time while still functioning. As a result, the system 100 is safer than existing devices.

In one embodiment, the system 100 may be utilized as a training and research tool. For example, law enforcement, mixed marital artists, private security, military, social officers, and others may be required to be trained in boxing, wrestling, hand-to-hand combat, mixed martial arts (MMA), striking, and so forth. Teaching proper use of bodily force and the use of deadly force is very difficult to teach. The system 102 provides a resource for measuring striking data for sports, self-defense, martial arts, and any number of other activities.

The inherent adrenaline rush that comes with deadly encounters and accidental deaths frequently occur due to errors in physical execution or the excessive use of force. For example, the system 100 may be utilized for training police departments. The system 100 may be utilized to measure striking and physicality. As a result, various individuals, athletes, professionals, and others may receive data analytics for managing and training for any number of potential events. Police officers, guards, or others charged with security may be trained to utilize incapacitating forces without using deadly forces.

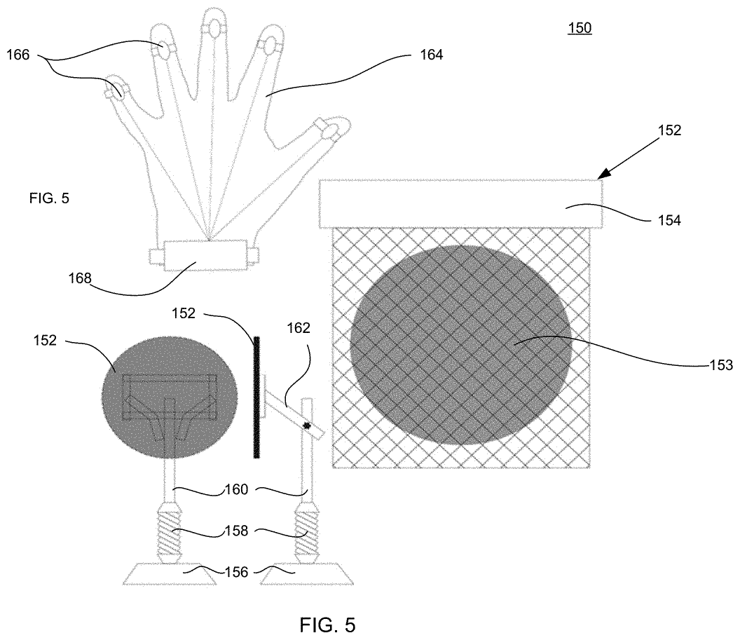

FIG. 5 is a pictorial representation of another impact system in accordance with an illustrative embodiment. The impact system 150 may include a sensor wall 152, sensors 153, a frame 154, a base 156, and adjustment 158, a support 160, an arm 162, and a glove 164 which may include sensors 166 and logic 168. In one embodiment, the impact system 150 may represent all or portions of the impact system 100 of FIG. 1.

The sensor wall 152, the sensors 153, and the frame 154 may be similar to the structure and components of FIGS. 1-4. In one embodiment, the various embodiments, components, and functionality may be integrated, exchanged, or combined in any number of combinations. As previously noted, the sensor wall 152 may be configured to sense any number of impacts or strikes. The impacts or strikes may be received from the body of a user or from any striking object or projectile. Any portion of the sensor wall 152 may be struck by the user. However, in some embodiments, the sensor wall 152 may include one or more target areas. The target areas may be associated with a cover utilized over or on the sensor wall 152, painted markings, or electronically displayed markings or indicators (e.g., light emitting diodes, embedded lights, externally projected lights, etc.). In one embodiment, the target areas may include additional padding or may extend from the rest of the sensor wall 152. For example, the target areas may represent the head, body, or torso of any individual. In one embodiment, the sensor wall 152 and other portions of the system 150 may be integrated into a humanoid or animal model or analog.

In one embodiment, the frame 154 may support the various electronic components of the impact system 150. For example, the impact system 150 may include one or more processors, transceivers, batteries, and controls. The battery may power the impact system 500 when not connected to a hardwired power source (e.g., plugged in to an outlet). The controls may allow the user to specify the mode of operation of the impact system and one or more training programs or routines that may be executed by the impact system 150 as default or custom training or testing programs, algorithms, routines, processes, or so forth.

In one embodiment, the adjustment 158 attached to the support 160 and may be utilized to vertically adjust the wall 152. A screw, pin, sleeve, socket, or other system may be utilized to secure the support 160/adjustment 158 to the base 156. The adjustment 158 may include any number of connectors, pins and holes, tightening mechanisms (e.g., screws, bolts, etc.), latching mechanisms, and so forth. The arm 162 may similarly include any number of adjustment mechanisms for moving, rotating, pivoting, raising and lowering, and otherwise modifying the position of the sensor wall 152 and the impact system 150. For example, the adjustment 158 and the arm 162 may be utilized to configure the impact system 150 for the height, striking, and techniques utilized by a user. In one embodiment, the arm 162 may attach to the sensor wall 152 utilizing a plate or frame utilizing any number of bolts, screws, pins, or other connectors. The frame, support 160 and the arm 162 may represent any number of tubes, bars, linkages, support, or framework that stabilizes the impact system 150 for the numerous impacts and strikes that are received. Any number of extensions, arms, or connectors may be utilized to position and orient the sensor wall 152 for optimal placement associated with the corresponding training. The arm 162 may connect directly to the wall 152, the frame 154, or a mount associated with either of those components.

In one embodiment, the impact system 150 is mobile, semi-mobile, or movable. For example, the base 156 may be moved between locations. The base 156 may be attached, fixed, or mounted to any number of structures or services, such as walls, ceilings, floors, and so forth. In one embodiment, the base 156 may be attached to a plate, latches, receptacles, or other interface points for easy movement and connection. The base 156 may also include one or more industrial strength suction cups or vacuum systems for connecting to the floor or ground in a specified location.

In one embodiment, the sensor wall 152 may be utilized without any specially configured equipment (e.g., gloves, pads, balls, arrows, etc.). In another embodiment, the glove 164 may be utilized as part of the impact system 150. The glove 164 may be configured to be worn on the user's right and left hands. In other embodiments, the glove 164 may represent a wearable sensory device that may be worn on feet, elbows, knees, head, shoulders, or other body parts. For example, the glove 164 may represent a sensor wrap that may be worn on various parts of the user's body. The glove 164 may also represent a sensory cover for a ball or other striking objects or projectiles. The components of the glove 164 may also be integrated with clothing (e.g., shoes, socks, shirts, gloves, head bands, sweat bands, etc.). The glove 164 may include a number of sensors 166. In one embodiment, the sensors 166 are active sensors that may sense forces exerted by or upon the hand of the user. In one example, the sensors 166 may be positioned in each finger of the glove 164 as well as the wrist position noted by the logic 168. For example, the sensors 166 may represent any number of accelerometers, gyroscopes, pressure sensors, capacitive sensors, and so forth.

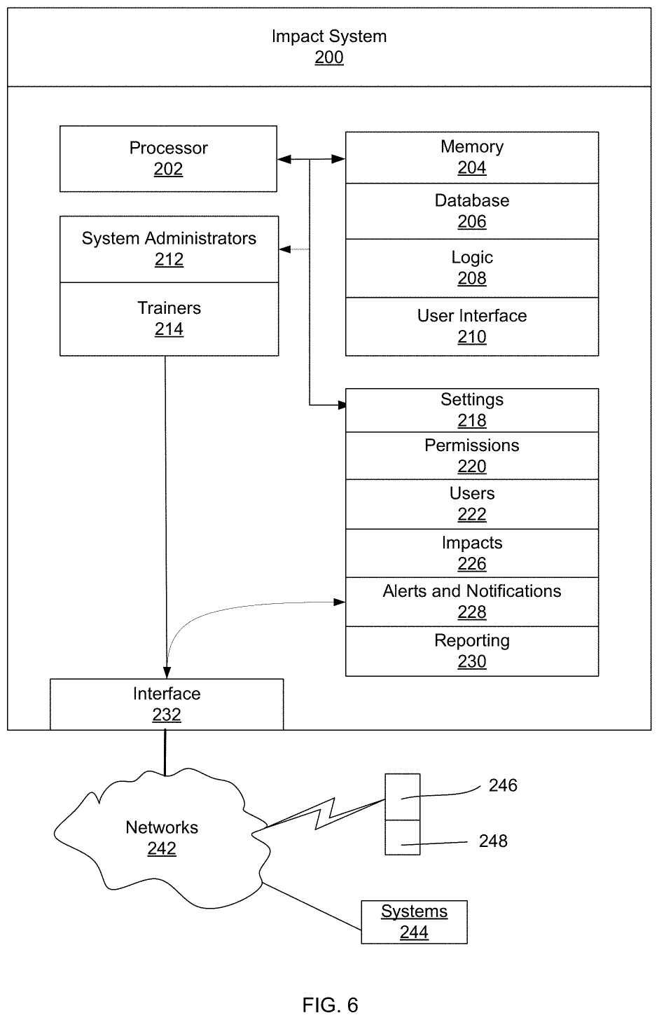

In one embodiment, all of the readings or measurements from the sensors 166 are communicated to the logic 168. The logic 168 may aggregate, analyze, process, communicate, or otherwise manage the sensor readings. The logic 168 may also include a number of sensors for determining information associated with the impact force. In one embodiment, logic 168 may communicate the sensor readings to the sensor wall 152 or other specified devices/users. The logic 168 may also include a wireless transceiver for sending and receiving information. The logic 168 may include a memory, processor, transceiver, and other components as described in FIG. 6.

In another embodiment, the sensors 166 may represent passive sensors. For example, the sensors 166 may represent radiofrequency identification (RFID) sensors or tags, beacons, or other sensors that are utilized to determine the location of the glove 164 relative to the wall 152. For example, the wall 152 may project a signal that activates the sensors 166 or is reflected back by the sensors 166 to indicate the location, position, orientation, velocity, striking or impact force.

FIG. 6 is a block diagram of an impact system 400 in accordance with an illustrative embodiment. In one embodiment, the impact system 400 may include a processor 202, a memory 204, a database 206, logic 208, a user interface 210, system administrators 212, trainers 214, settings 218, permissions 220, users 222, orders 226, alerts and notifications 228, reporting 230, and an interface 232.

The impact system 400 may communicate with networks 242, systems 244, and wireless devices 246 utilizing applications 248. In one embodiment, the impact system 400 is a system, computing device, or group of networked or distributed computing devices. The impact system 400 may have any number of hierarchical users including, system administrators, trainers, coaches, service providers, and other users or groups.

In one embodiment, the processor 202 is circuitry or logic enabled to control execution of a set of instructions. The processor 202 may be microprocessors, digital signal processors, application-specific integrated circuits (ASIC), central processing units, or other devices suitable for controlling an electronic device including one or more hardware and software elements, executing software, instructions, programs, and applications, converting and processing signals and information, and performing other related tasks. The processor 202 may be a single chip or integrated with other computing or communications elements.

The memory 204 is a hardware unit, component, device, or recording media configured to store data for subsequent retrieval or access at a later time. The memory 204 may be static or dynamic memory. The memory 204 may include a hard disk, random access memory, cache, removable media drive, mass storage, or configuration suitable as storage for data, instructions, and information. In one embodiment, the memory 204 and processor 202 may be integrated. The memory 204 may use any type of volatile or non-volatile storage techniques and media.

In one embodiment, the database 206 may be utilized to store data 226. The data 226 may include information and data related to users of the impact system, trainers, user profiles, administrators, training sessions strikes/impacts, diagnostic data, training programs, and so forth. In one embodiment, all or portions of the impact system 200 may be saved in a remote device(s), such as servers, that may communicate with a locally installed impact system/wall through one or more networks. The database 206 may include a database management system such as SQL (and variations), Access, Oracle, DB2, or other developing systems.

In one embodiment, the interface 232 may include a transceiver configured to both transmit and receive communications for the impact system 400. The communications may represent wired or wireless communications. For example, the interface 232 may include transceivers, cards, or interfaces that enable communications through Ethernet, Wi-Fi, Bluetooth, cellular signals, or so forth. The networks 242, systems 244, wireless devices 246 and applications 248 may represent all or a portion of the system 100 of FIG. 1. In one embodiment, information, settings, and data utilized by the impact system 400 is saved or duplicated to one or more redundant systems for backup, failover, or network processing utilizing any number of backup standards, formats, and protocols.

In one embodiment, system administrators 212 may monitor, control, or manage utilization of the impact system 400. The system administrators 212 may be allowed to manage the setup of information, settings, and modules for the trainers 214. In one embodiment, the system administrators 212 may be prevented from seeing specific types of data (e.g., user biometric data). The trainers 214 may represent individuals, groups, teams, medical professionals (e.g., doctors, nurses, physical therapists, etc.), and so forth.

The user interface 210 may represent any number of touch screens, buttons, scroll wheels, joysticks, interactive voice response systems, or other interface components. The user interface 210 may also be represented by programs, applications, secure access protocols or systems made available through the impact system 400, such as the user interface 210, or alternatively, the applications 248, or the systems 244. The user interface 210 may present a dashboard or portal for managing utilization of the impact system 200 by system administrators, trainers 214, users 222, and others. In one embodiment, the training and striking functions of the user interface 210 may be accessed through a mobile app, desktop application interface, or webpage. In one embodiment, the user interface 210 may display any number of icons, images, soft-buttons, drop-down menus, videos, hyperlinks, internal links, scroll wheels, tabs, Windows, or other selection or display components. As a result, the trainers 214 may be able to customize the types of training required by specifying information, such as the position of strikes, impact thresholds required for a successful strength (e.g., above or below specified force levels), displayed targets, indicators, and information, frequency, duration, and so forth.

The system administrators 212 may have the capacity to add, edit, archive, and delete the trainers 214, settings 218, permissions 220, users, alerts and notifications 228, and reporting 230 based on performance, regulations, laws, certifications, qualifications, jurisdiction, location, errors, mistakes, or so forth. In one embodiment, the logic 208 is the software, programming, hardware, logic, or instructions for processing impacts 226 as are herein described. The logic 208 may also be integrated with other components of the impact system 200 or platform (e.g., processor 202, memory 204, database 206, user interface 210, etc.). In one embodiment, the logic 208 may generate status information with regard to the impacts 226. For example, the status information may indicate when impacts 226 are detected, where (position and orientation) the impacts 226 were detected on an associated wall, striking velocity, impact trends, historical information, impact feedback, and so forth.

The impact system 400 stores and provides access to the impacts 226. As a result, the system administrators 212, trainers 214, and users 222 may log information associated with their associated impacts 226. The trainers 214 may also post public notes, comments, alerts, notifications, associated with data being recorded by the impact system 400 through the individual accounts. Applicable policies, rules, laws, industry practices, and so forth may also be made available to individuals, groups, businesses, users, and others that may access the impact system 400 or interfaces that interact with the impact system 400. For example, the impact system 400 may remind a user that he/she is being trained to subdue and incapacitate without significantly injuring or killing a person being struck The impact system 400 may be accessible through a webpage, mobile applications, telephonic systems, and so forth for performing communications, updates, programming, customization, or so forth. The users may utilize the applications 248 (e.g., Android, iOS, etc.) to communicate with the user interface 210 to view impacts 226 associated with specified users 222. The user interface may provide an easy to navigate and user friendly interface with quick search utilities and filters. The applications 248 may be associated with particular striking programs, games, or tests that are utilized to facilitate the one or more users interacting with the impact system 200.

In one embodiment, the impact system 200 may be a pay per use system. As a result, the communications with the impact system 400 are secured for sensitive electronic protected health information, financial transactions, and to comply with applicable laws, such as HIPAA, privacy laws, financial regulations, and so forth. Communications with the impact system 400, whether in real-time or file transfers, may be encrypted or utilize other secure data transmission protocols (i.e., SSL, https, security certificates, etc.). The impact system 400 may also be configured to communicate with any number of databases or systems maintained by the system administrators, such as electronic databases. The applications 248 may process orders and data even if one of the networks 242 is not currently available or if the wireless devices 246 and the systems 244 are offline. Synchronization methods and modes may be utilized as necessary.

The settings 218 and permissions 220 may specify information for the users (e.g., sex, height, weight, training program, expected impacts, etc.), system administrators 212, trainers 214, and so forth. The users 222 may include accounts, user profiles (e.g., age, sex, health issues, insurance, training status, etc.), payment information, and other application information for the users that access the impact system 400. The impacts 226 indicate information and data applicable to past and current impacts, training sessions, and so forth. The impacts 226 associated with specific users 222, trainers 214, and system administrators 212 may be accessed as allowed.

In one embodiment, the alerts and notifications 228 may provide alerts, notifications, or other relevant information to the applicable users 222, trainers 214, system administrators 212, applications 248, wireless devices 246 or so forth. The alerts and notifications may include program based messages, audio messages, video messages, text messages, in-app messages, emails, and so forth. The alerts and notifications 228 may also indicate striking information, encouragement, warnings (e.g., excessive impact power, insufficient impact power, improper placement, etc.), real-time feedback, or so forth.

In one embodiment, the reporting 230 may be utilized to communicate impact information which may include statistics, charts and graphs, trends, user status, user biometrics, transaction information, impact/striking details, and so forth. In one embodiment, the reporting 230 may be based on users 222, location, trainers 214, date ranges, and so forth. The reports are configured to be customizable to track and display a variety of information and data available through the impact system 400.

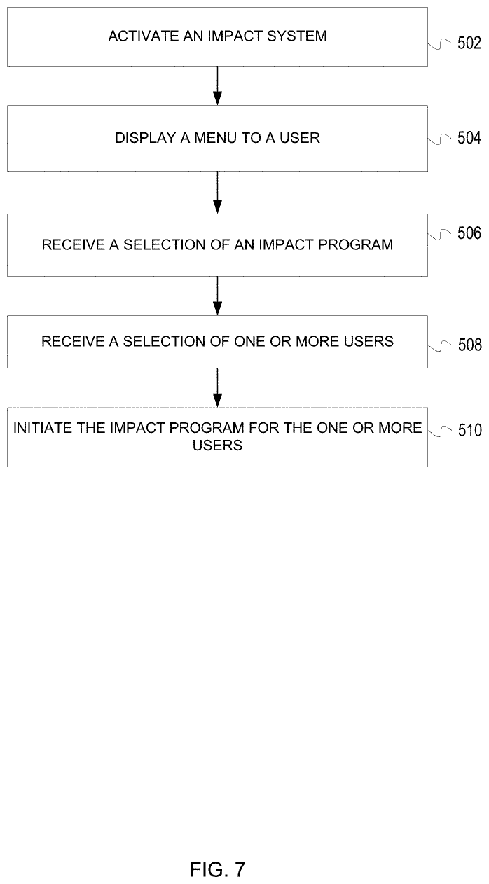

FIG. 7 is a flowchart of a process configuring the impact system in accordance with an illustrative embodiment. The process of FIG. 7 may be implemented by an impact system, platform, equipment, or device. The impact system may represent a standalone system or networked system.

In one embodiment, the process of FIG. 7 may begin by activating an impact system (step 502). For example, a power switch may be utilized to power on or enable the impact system. In another example, a specialized program, application, my, portion of the operating system, or sets of instructions may be utilized to initiate the impact system.

Next, the impact system displays a menu to the user (step 504). The menu may represent a user interface for figuring the impact system. In one embodiment, the impact system may include a play, touchscreen, mouse, keyboard, cursors, buttons, scroll wheel, or other components for receiving user input and displaying applicable information. Any number of externally connected peripherals may also be connected to the impact system. The menu may display any number of options, drop-down menus, windows, icons, selection elements, or so forth. The impact system may utilize hardware, software, firmware, or a combination of components to interact with the user or users.

Next, the impact system receives the selection of an impact program (step 506). The impact program may represent a general program utilize to track impacts or activities associated with the impact system. In another example, the impact program may be specific to a type of activity, user, or striking object utilized with the impact system. For example, high interval training utilizing a medicine ball may be selected as the impact program. Other examples, may include speed training, impact training, boxing, mixed martial arts (combined hand, feet, and knee strikes), pattern training, weapons training, accuracy testing, and so forth. The impact program may be selected for beginners, intermediate levels, experts/professionals, elderly individuals, physical therapy, and so forth.

Next, the impact system receives a selection of one or more users (step 508). The selection of the one or more users may include a user name, nickname, identifier, age, sex, birth date, physical status, training status, known physical conditions or issues, and so forth. In one embodiment, each user may have associated user preferences that are entered utilizing the IMPAC system for sent to the IMPAC system from a third-party device, such as smart phone executing a program that interfaces with the impact program or configuration of the impact system. One or more users may utilize the impact system simultaneously, concurrently, or sequentially. For example, three different users may be striking or otherwise utilizing the impact system at once. The three different users may have different skill levels, needs, or so forth. In one embodiment, the impact system may identify a user utilizing a cell phone signal, device identifier, RFID card, communicating biometrics (e.g., head band, wireless earpieces, smart watch, chest strap, etc.) to automatically implement a preestablished training or testing program. For example, a user may incrementally increase their training program over hours, days, weeks, or so forth.

Next, the impact system initiates the impact program for the one or more users (step 510). Programs for different users may be started at different times using different configurations and user preferences. The initiation and activation of the impact system may be performed automatically or in response to user input or detected signals, stimuli, input, or other feedback.

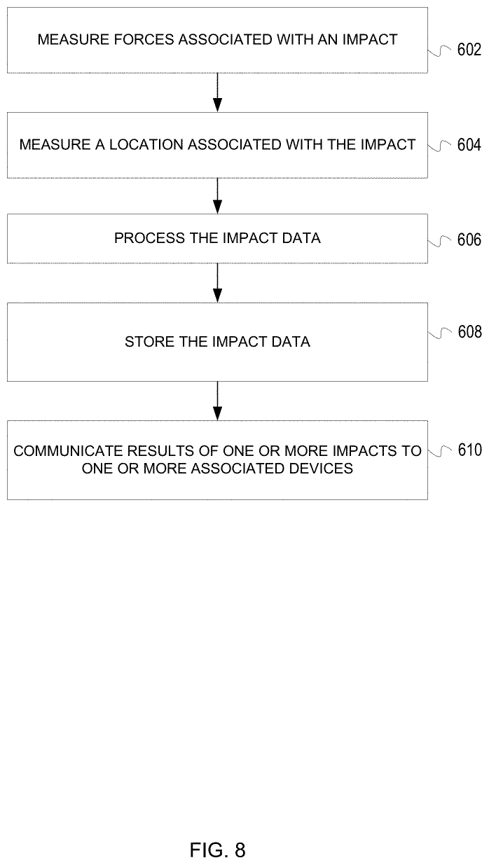

FIG. 8 is a flowchart of process for processing data from an impact system in accordance with an illustrative embodiment. In FIG. 8, the process may begin with the impact system measuring forces associated with an impact (step 602). The forces may be measured by one or more sensors integrated with or external to the impact system. For example, the sensors may measure the forces in velocity, force per area, impact force dispersal, accuracy relative to a target, reaction time, impact angle, and other similar parameters. The measurements may also relate to the forces of experience as a function of time. Although referred to as an impact, the impact system to measure a number of different strikes or impacts received. In one embodiment, the impact system may include a number of stations, or assigned areas that may be assigned to each user.

Next, the impact system measures a location associated with the impact (step 604). The location may know the position on the impact system or wall that was struck as well as the designated or intended target. For example, the impact system may note proximity or deviations from a designated striking point. The location may be relative to the target, impact angle if applicable and other applicable information.

Next, the impact system processes the impact data (step 606). The impact data may be associated with steps 602 and 604. The impact data may also represent other data, measurements, or values courted by the impact system or associated devices. The impact system may utilize one or more processors to convert, analyze, and otherwise processed the impact data. In another embodiment, the impact data may be processed by a computing or communications device physically or wirelessly associated with the impact system.

Next, the impact system stores the impact data (step 608). The impact data may be stored locally in one or more memories, hard drives, use, discs, or other storage points available through the impact system. In another example, the impact data may be stored in an external device as previously noted.

Next, the system communicates results of one or more impacts to one or more associated devices (step 610). In one embodiment, the results of impacts may be communicated in real time. For example, and associated tablet that is paired with the impact system may receive the results for display to a trainer, medical professional, interested party, for the user himself/herself. For example, the impact results may be communicated to a display integrated with the impact system. In another example, the impact data may be routed through one or more networks, servers, routers, or so forth to the intended devices, systems, equipment, components, individuals, teams, organizations, or so forth.

The illustrative embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computing system (or other electronic device(s)) to perform a process according to embodiments, whether presently described or not, since every conceivable variation is not enumerated herein. A machine readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (e.g., through the Internet using an Internet Service Provider).

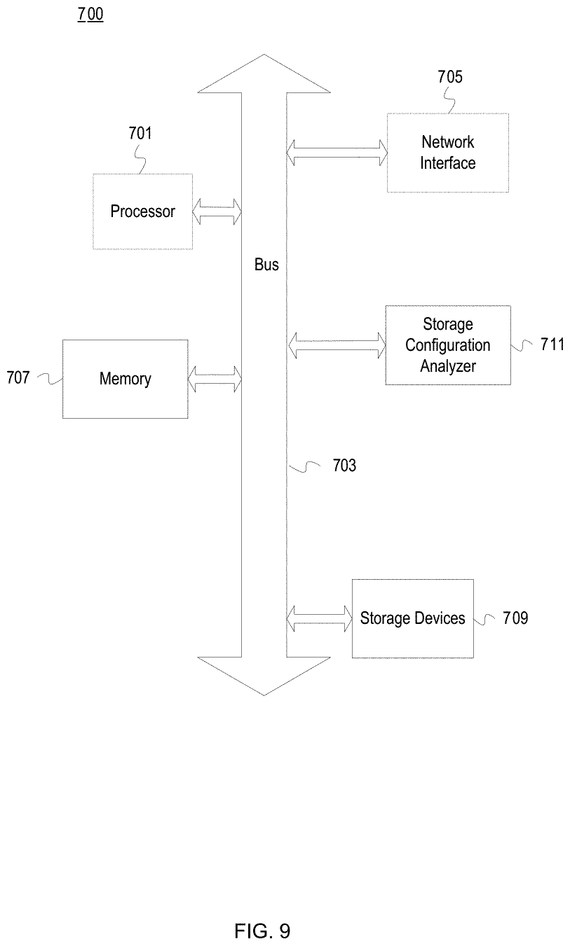

FIG. 9 depicts a computing system 700 in accordance with an illustrative embodiment. For example, the computing system 700 may represent an electronic computing or communications device, such as an augmented reality system. The augmented reality system may communicate with wireless earpieces, augmented reality glasses, sensors, or other electronics, devices, systems, equipment, or components. The computing device 700 may be utilized to receive user settings, instructions, or feedback for controlling the power management features of the wireless earpieces together and separately. The computing system 700 includes a processor unit 701 (possibly including multiple processors, multiple cores, multiple nodes, and/or implementing multi-threading, etc.). The computing system includes memory 707. The memory 707 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computing system also includes a bus 703 (e.g., PCI, ISA, PCI-Express, HyperTransport®, InfiniBand®, NuBus, etc.), a network interface 705 (e.g., an ATM interface, an Ethernet interface, a Frame Relay interface, SONET interface, wireless interface, etc.), and a storage device(s) 709 (e.g., optical storage, magnetic storage, etc.). The system memory 707 embodies functionality to implement embodiments described above. The system memory 707 may include one or more functionalities that recognize user information for communicating audio content to the wireless earpieces, augmented reality glasses, or so forth. The system memory 707 may also process audio input received from wireless earpieces, augmented reality glasses, or other devices. Code may be implemented in any of the other devices of the computing system 700. Any one of these functionalities may be partially (or entirely) implemented in hardware and/or on the processing unit 701. For example, the functionality may be implemented with an application specific integrated circuit, in logic implemented in the processing unit 701, in a co-processor on a peripheral device or card, etc. Further, realizations may include fewer or additional components not illustrated in FIG. 9 (e.g., video cards, audio cards, additional network interfaces, peripheral devices, etc.). The processor unit 701, the storage device(s) 709, and the network interface 705 are coupled to the bus 703. Although illustrated as being coupled to the bus 703, the memory 707 may be coupled to the processor unit 701.

The illustrative embodiments are not to be limited to the particular embodiments described herein. In particular, the illustrative embodiments contemplate numerous variations in the type of ways in which embodiments may be applied. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of embodiments, processes or methods of the invention. It is understood that any other modifications, substitutions, and/or additions may be made, which are within the intended spirit and scope of the disclosure. For the foregoing, it can be seen that the disclosure accomplishes at least all of the intended objectives.

The previous detailed description is of a small number of embodiments for implementing the invention and is not intended to be limiting in scope. The following claims set forth a number of the embodiments of the invention disclosed with greater particularity.

What is claimed is:

1. An impact system, comprising:
a sensor wall defining a substantially vertical wall, wherein a plurality of sensors are embedded in the sensor wall, and wherein the plurality of sensors are configured to sense one or more impacts simultaneously or in a series from a user;
a base securing the sensor wall, wherein the base is attached to a floor or ground; and
supports integrated with the sensor wall securing the sensor wall to the base.

2. The impact system of claim 1, wherein the base includes a sleeve configured to receive the sensor wall, and wherein the base includes a flange for securing the base to the floor or the ground utilizing one or more connectors.

3. The impact system of claim 2, wherein the connectors represent bolts.

4. The impact system of claim 1, wherein the sensor wall communicates with one or more electronic devices.

5. The impact system of claim 4, wherein the sensor wall communicates with the one or more electronic devices through one or more networks.

6. The impact system of claim 1, further comprising:
indicators integrated with a surface of the sensor wall that display striking information.

7. The impact system of claim 6, wherein the striking information includes at least a time to strike and a location on the sensor wall to strike.

8. The impact system of claim 1, wherein the plurality of sensors measure a time of impact, a location of the impact on the sensor wall, a speed of the impact, and the force of the impact.

9. The impact system of claim 1, wherein the plurality of sensors include accelerometers and capacitance or resistive sensors.

10. The impact system of claim 1, wherein the base is removable attached to the ground or floor.

11. The impact system of claim 1, further comprising:
logic configured to execute one or more training or testing programs for a user.

12. The impact system of claim 11, wherein the sensor wall sense impacts directly from the user utilizing one or more body parts.

13. A method of utilizing a sensor wall for detecting impacts, comprising:
detecting an impact;
measuring impact data associated with the impact;
processing the impact data to generate impact results; and
communicating the impact results to one or more associated devices.

14. The method of claim 13, further comprising:
calibrating a plurality of sensors within the sensor wall;

15. The method of claim 13, wherein the processing further comprises:
analyzing the impact data to generate results, wherein the results are communicated as part of the impact information.

16. The method of claim 13, wherein the impact data includes a location of the impact on the sensor wall, a time of the impact, a speed associated with the impact, and a force associated with the impact.

17. The method of claim 13, further comprising:
securing the sensor wall to a floor or ground utilizing a base, wherein the base includes a sleeve for receiving the sensor wall.

18. The method of claim 13, further comprising:
presenting one or more targets to one or more users of the sensor wall.

19. The method of claim 13, further comprising:
uploading one or more training or testing programs to be executed by logic of the sensor wall for one or more users.

20. An impact system, comprising:
a sensor wall defining a substantially vertical wall, wherein an exterior surface of the sensor wall is covered by an impact surface, wherein one or more indicators are positioned within the sensor wall for indicating information for striking the sensor wall, wherein a plurality of sensors are embedded in the sensor wall, and wherein the plurality of sensors are configured to sense one or more impacts from a user;
a base securing the sensor wall; and
supports integrated with the sensor wall securing the sensor wall to the base.
